(19) United States
(12) Patent Application Publication
(10) Pub. No.: US 2010/0237144 A1
(43) Pub. Date: Sep. 23, 2010

(54) Mail Box

(76) Inventor: David Wolfe, Murphy, TX (US)

Correspondence Address: David Wolfe, 201 Timber Ridge Dr, Murphy, TX, 75094, US

(21) Appl. No.: 12/706,600

(22) Filed: Feb. 16, 2010

Related U.S. Application Data
(60) Provisional application No. 61/152,789, filed on Feb. 16, 2009.

(51) Int. Cl. A47G 29/122; A47G 29/124; F21L 4/08

(52) U.S. Cl. 232/39; 362/183

(57) ABSTRACT

A mailbox for holding mail may include a housing to house the mail and a stand to support the housing. The housing may include a security shelf to prevent access to a bottom portion of the housing. The housing may include a lower door and the lower door may be pivotable to access the bottom portion of the housing. The lower door may include a lock, and the housing may include a fixed wall to prevent access to the housing. The housing may include a flap to cooperate with the fixed wall, and the security shelf may include a horizontal section. The security shelf may include an inclined section, and the mailbox may include a light. The light may be powered by solar, and the light may be powered by landscaping power.

### PRIORITY

The present invention claims priority under 35 USC section 119 and based upon a provisional application which was filed on Feb. 16, 2009 with a Ser. No. 61/152,789.

### FIELD OF THE INVENTION

The present invention relates to a new and improved mail box.

### BACKGROUND OF THE INVENTION

Conventional mail boxes provide little or no security against the unauthorized removal of mail placed in the box by the U.S. Postal Service. A typical mail box comprises a closed elongate housing, having at one end a hinged door that can be opened to allow mail to be inserted or withdrawn from the housing. This arrangement makes it easy for the U.S. Postal Service to deliver mail to the interior of the mail box. Unfortunately, it is equally easy for unauthorized persons to remove mail from the box.

### SUMMARY

A mailbox for holding mail may include a housing to house the mail and a stand to support the housing. The housing may include a security shelf to prevent access to a bottom portion of the housing.

The housing may include a lower door and the lower door may be pivotable to access the bottom portion of the housing.

The lower door may include a lock, and the housing may include a fixed wall to prevent access to the housing.

The housing may include a flap to cooperate with the fixed wall, and the security shelf may include a horizontal section.

The security shelf may include an inclined section, and the mailbox may include a light.

The light may be powered by solar, and the light may be powered by landscaping power.

The mailbox may include a display including indicia, and the display may be detachably connected to the stand.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the mailbox of the present invention;

FIG. 2 illustrates a side view of the mailbox of the present invention;

FIG. 3 illustrates a front view of the mailbox of the present invention.

### DETAILED DESCRIPTION

The present invention provides an improved mail box in which, while the insertion of mail into the box is still easy, it is not easy to remove that mail without opening a barrier that can be secured in place to restrict access to the mail box interior. The barrier may be secured in place by a lock. The mailbox of the present invention may include lights which may be solar powered or may be powered from a 12 V source such as landscape circuitry.

In another aspect of the invention, a mail box is mounted on a stand which includes a device for removably housing a visual display, such as a decorative panel or a panel depicting a symbol or logo, such as the logo of a sports team or which may correspond to a holiday such as a Santa Claus. Preferably the stand is in the form of a hollow rectangle, oval or other appropriate shape having a fastening device to detachably hold the visual display such as opposing slots which may extend from front to back in either its front or rear surface to receive the above described visual display which may be rectangular, oval or other appropriate shape.

The invention will now be described with reference to the accompanying drawings which show a mail box embodying the invention.

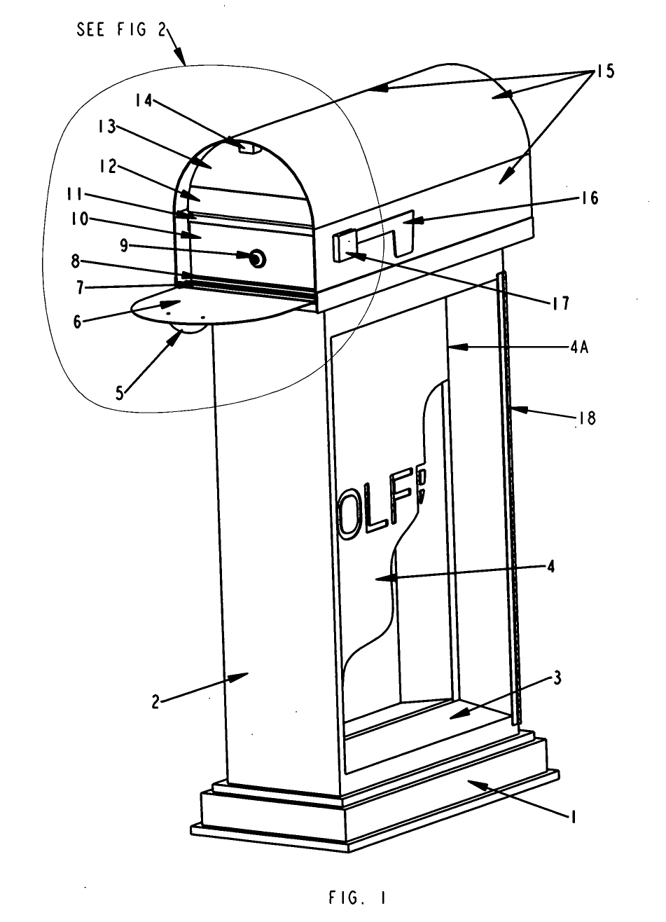

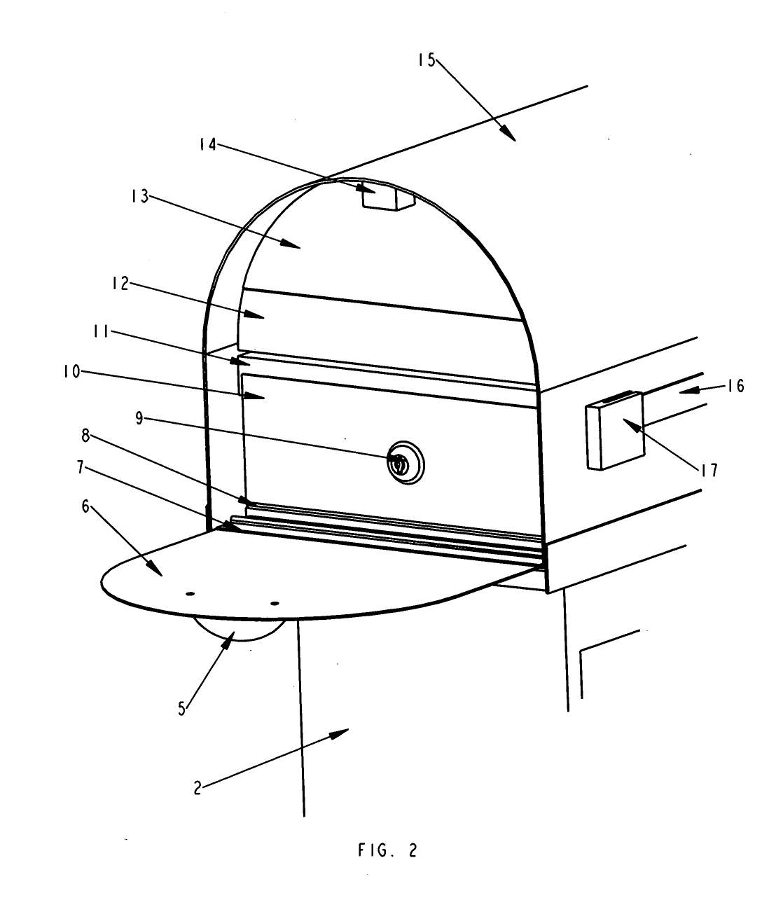

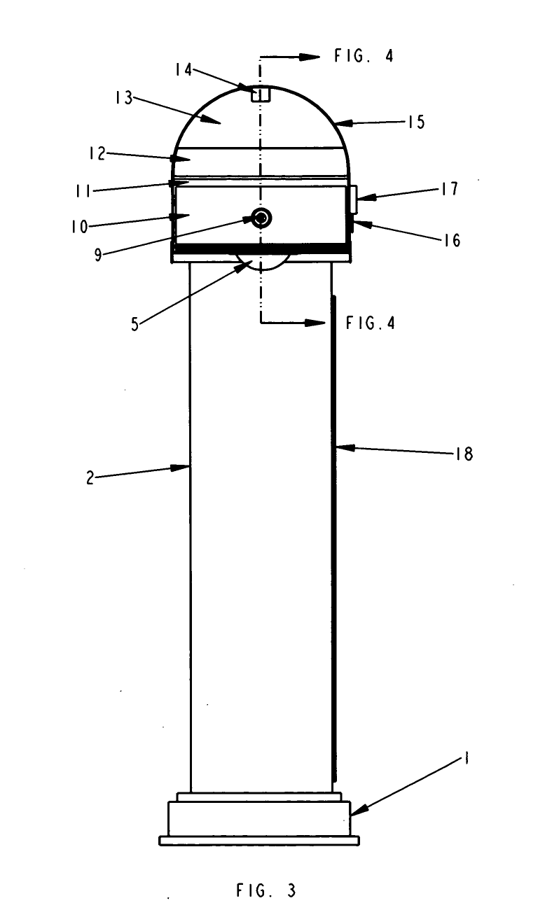

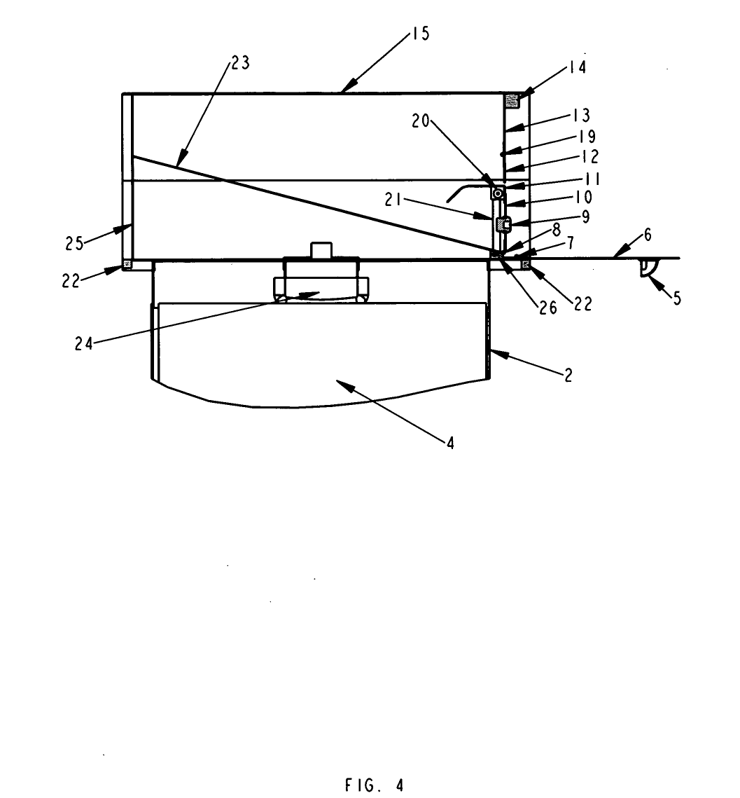

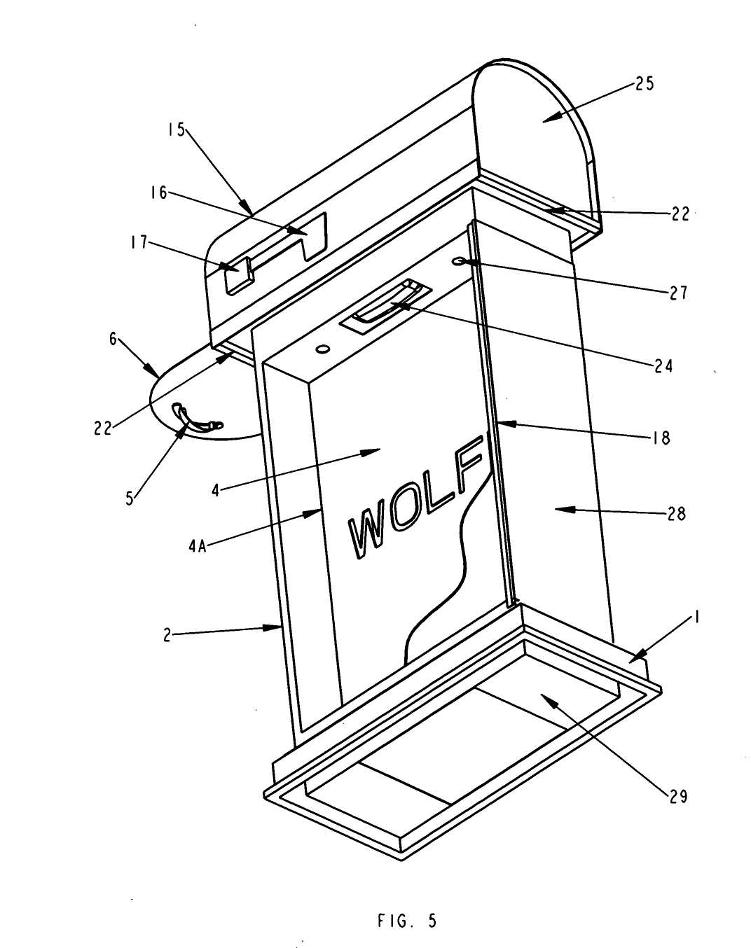

In the drawings, FIG. 1 shows a perspective view of a mail box embodying the invention, the interior structure being shown by dotted lines, FIG. 2 is a front elevation of the mail box of FIG. 1 with the end door removed. FIG. 3 is a side elevation of the mail box of FIG. 1 showing interior detail in dotted lines.

The mail box 10 may comprise an elongate housing 11, approximately 10 inches high or other appropriate dimension, may have a substantially flat or horizontal bottom wall 13, vertical side walls 15 and 17, an arched top wall 19 extending between the upper edges of the side walls 15, 17, and a rear wall 21 which may extend between the side walls 15, 17 and the bottom wall 13. The walls 13, 15, 17, 19 and 21 together define an enclosure 20, approximately 23 inches long or other appropriate dimension, having an open front end for receiving mail and for holding that mail for pick-up by the addressee. The mailbox 10 may be supported on a stand 25 which is described in more detail below.

The open front end of the housing 11 may be remotely opposed from the rear wall 21 has a door 18 which may be pivotably connected by a piano hinge 24a or other appropriate devices to the front end of the bottom wall 13 and configured to close the open end of the housing 11 to protect the contents from wind, rain and other sources of harm. The door 18 may be held closed by friction.

In the present invention, a security structure is provided within the enclosure 20 behind the door 18 to prevent unauthorized access to the contents of the enclosure 20. The security structure may include elements as best seen in FIGS. 1 and 3. The open end of the enclosure 20 may include a lower door 22, which may be pivotably connected along its lower edge to the bottom wall 13 by a piano hinge 24. The movable door 22 may be positioned behind the door 18 to provide enhanced security for the mail. The door 22 can be moved between a lowered, substantially horizontal open position and a raised, closed position (which may be substantially vertical) in which it obstructs the lower portion of the open end of the enclosure 20. The door 22 may include a lock 60 in order to prevent the movement of the door 22. The upper portion of the open end of the enclosure 20 is closed by a fixed wall 26 which may be substantially vertical and which secured to the top wall 19 and extending to the upper ends of the side walls 15,17. A flap 28 may be mounted to the lower edge of the wall 26. The flap 28 may be pivotably connected along the lower edge of the wall 26 by a piano hinge 30 or other appropriate device. The lower edge of the flap 28 may be arranged to juxtapose the upper edge of the door 22. A spring (not shown) may bias the flap 28 towards the vertical position in which the wall 26, flap 28, and door 22 together close the open end of the enclosure 20. The flap 28 can, however, be pivoted or pushed open to provide a slot or opening, about 1¼ inches in vertical dimension (or other suitable dimensions), allowing mail to be delivered to the interior of the enclosure 20.

As shown in FIG. 1, a plate or baffle 27 forming a security shelf is provided in the interior of the housing 11 and extends across the interior of the housing 11. The sides of the baffle 27 are secured to the interiors of the side walls 15 and 17. The security shelf prevents a hand which may be unauthorized from entering the bottom portion of the interior of the housing 11.

The baffle 27 may comprise a first, generally horizontal section 29 extending from the open end of the housing 11 approximately 2 to 3 inches (or other appropriate dimension) into the interior and a second, downwardly inclined section 31, inclined at about 15 to 25 degrees to the horizontal and terminating about 2 inches above the bottom wall 13. At its front edge, the baffle 27 has a downwardly extending vertical flange (not shown) which is secured at its edges to the side walls 15, 17. A lock 60 is provided on the door 22 and engages behind the flange to releasably secure the door 22 in the closed position.

A mail-receiving plate 34 is provided within the enclosure 20. The plate 34 extends across the entire width of the enclosure. At its rear end the plate 34 is connected to the rear wall 21 about 5 inches (or other appropriate dimensions) above the bottom wall 13. A horizontal section 36 of the plate 34 extends about 3-4 inches from the rear wall 21 and leads to a sloping portion 38 that extends downwardly at an angle of about 15 degrees (or other appropriate dimension) to the horizontal. The front end of the sloping portion 38 may be connected to the bottom wall 13 near the bottom edge of the lower door 22.

The mail box may be constructed, for example, in 16 gage steel or moulded in ⅜ inch plastic or other appropriate material.

In use, a person delivering mail pushes open the flap 28 and inserts the mail through the slot between the wall 26 and the lower door 22. The mail drops past the baffle 27 onto the receiving wall 34 and slides forward to a position below the baffle 24. At that time, access to and removal of the mail is prevented by the baffle 27 and the door 22. The authorized user of the mail box, however, can retrieve the mail by unlocking the lock 60 and opening the door 22.

As previously mentioned, the mailbox 10 is mounted on a stand 25, approximately 34 inches high and 7 inches wide (other dimensions are within the scope of the invention). In accordance with another aspect of the invention, the stand 25 incorporates an artistic or commercial display.

As best seen in FIGS. 2 and 3, the stand 25 may comprise a base 41 which is adapted to be secured, for example by nuts and bolts, to a concrete pedestal in the ground or on a support surface. A rectangular case 43 (other shapes such as oval or within the scope of the present invention) is secured on the base 41. The case 43 includes a bottom 45, a front 47, a top 49 and a rear 51.

The rear 51 may include a vertical slot-like opening 53 providing access to the interior space defined by the bottom 45, front 47, top 49 and rear 51. Additional slots (not shown), in register with the slot 53 may be provided in the bottom 45, top 49 and rear 51. A rectangular sign or artistic representation can be inserted through the opening 53 and held in a vertical position by the registering slots 55. A door (not shown) may be pivotably connected to the rear 51 by a vertical piano hinge. The door may include a lock to secure the door across the slot 53 in the rear 51 to prevent unauthorized removal of the sign 57.

Examples of the design that could be incorporated in the sign are the logos of professional or college sports teams, or businesses.

Although the Figures illustrating an embodiment in which there is a single sign or artwork, it will be clear to persons of ordinary skill in an art that the stand 25 could have two spaced apart slot-like openings 53 and matching registering slots 55 and that two signs or pieces of art work could be inserted into the stand.

Advantageously, a light kit 59 may be provided on the underside of the top 49 and illuminates the sign or art work housed in the stand 25. The light kit 59 can be powered by solar cells provided on the device, by batteries, or by connection to an external source of electric power. Additional lighting may be provided for the sign. For example, by LED lights mounted on the inwardly facing surfaces of the front 47 and rear 51. A light may also be provided for the interior of the enclosure 20, which is operated, for example, by opening and closing the door 22.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A mailbox for holding mail, comprising:
a housing to house the mail;
a stand to support the housing;
the housing including a security shelf to prevent access to a bottom portion of the housing.

2) A mailbox for holding mail as in claim 1, wherein the housing includes a lower door.

3) A mailbox for holding mail as in claim 2, wherein the lower door is pivotable to access the bottom portion of the housing.

4) A mailbox for holding mail as in claim 3, wherein the lower door includes a lock.

5) A mailbox for holding mail as in claim 1, wherein the housing includes a fixed wall to prevent access to the housing.

6) A mailbox for holding mail as in claim 5, wherein the housing includes a flap to cooperate with the fixed wall.

7) A mailbox for holding mail as in claim 1, wherein the security shelf includes a horizontal section.

8) A mailbox for holding mail as in claim 7, wherein the security shelf includes an inclined section.

9) A mailbox for holding mail as in claim 1, wherein the mailbox includes a light.

10) A mailbox for holding mail as in claim 9, wherein the light is powered by solar.

11) A mailbox for holding mail as in claim 9, wherein the light is powered by landscaping power.

12) A mailbox for holding mail as in claim 1, wherein the mailbox includes a display including indicia.

13) A mailbox for holding mail as in claim 12, wherein the display is detachably connected to the stand.
